(19) United States
(12) Patent Application Publication
(10) Pub. No.: US 2023/0377000 A1
(43) Pub. Date: Nov. 23, 2023

(54) INFORMATION PROCESSING DEVICE, PROVISION SYSTEM, AND PROVISION METHOD

(71) Applicant: Mitsubishi Electric Corporation, Tokyo (JP)

(72) Inventors: Masahiro ABUKAWA, Tokyo (JP); Yasushi SUGAMA, Tokyo (JP); Satoru FURUTA, Tokyo (JP)

(73) Assignee: Mitsubishi Electric Corporation, Tokyo (JP)

(21) Appl. No.: 18/230,349

(22) Filed: Aug. 4, 2023

Related U.S. Application Data
(63) Continuation of application No. PCT/JP2021/009776, filed on Mar. 11, 2021.

(51) Int. Cl. G06Q 30/0251

(52) U.S. Cl. CPC G06Q 30/0261; G06Q 30/0269

(57) ABSTRACT

An information processing device includes an acquisition unit that acquires user identification information as information identifying a user and position information as at least one item of information out of present position information as information indicating the user's present position and destination information as information indicating a destination, acquires purchase information indicating a purchased item purchased by the user in the past by using the user identification information, and acquires a learned model, an estimation unit that estimates an advertisement to be provided to the user by using the position information, the purchase information and the learned model, and a provision control unit that executes a process for providing the advertisement to the user.

### CROSS-REFERENCE TO RELATED APPLICATION

This application is a continuation application of International Application No. PCT/JP2021/009776 having an international filing date of Mar. 11, 2021.

### BACKGROUND OF THE INVENTION

### 1. Field of the Invention

The present disclosure relates to an information processing device, a provision system, and a provision method.

### 2. Description of the Related Art

Terminal devices such as smartphones and tablet terminals are widespread in recent years. A user views an advertisement displayed on a terminal device and that leads to an increase in the consumer appetite. In such a circumstance, there has been proposed a technology regarding the displaying of an advertisement (see Patent Reference 1). For example, an advertisement display terminal in the Patent Reference 1 acquires advertisement data based on a movement history record from an advertisement delivery server and displays the acquired advertisement data.
Patent Reference 1: Japanese Patent Application Publication No. 2015-114755

In the above-described technology, the advertisement data based on the movement history record is displayed. However, there are cases where the advertisement data based exclusively on the movement history record cannot be regarded as an advertisement appropriate for the user.

### SUMMARY OF THE INVENTION

An object of the present disclosure is to provide an advertisement appropriate for the user.

An information processing device according to an aspect of the present disclosure is provided. The information processing device includes an acquisition unit that acquires user identification information as information identifying a user and position information as at least one item of information out of present position information as information indicating the user's present position and destination information as information indicating a destination, acquires purchase information indicating a purchased item purchased by the user in the past by using the user identification information, and acquires a first learned model, an estimation unit that estimates an advertisement to be provided to the user by using the position information, the purchase information and the first learned model, and a provision control unit that executes a process for providing the advertisement to the user.

According to the present disclosure, an advertisement appropriate for the user can be provided.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing a provision system in a first embodiment;

FIG. 2 is a diagram showing hardware included in an information processing device in the first embodiment;

FIG. 3 is a block diagram showing functions of the information processing device in the first embodiment;

FIG. 4 is a diagram showing an example of a movement information management table in the first embodiment;

FIG. 5 is a diagram showing an example of a delivery information management table in the first embodiment;

FIG. 6 is a flowchart showing an example of a process executed by the information processing device in the first embodiment;

FIG. 7 is a flowchart showing an example of a process executed by an information processing device in a second embodiment;

FIG. 8 is a block diagram showing functions of an information processing device in a third embodiment;

FIG. 9 is a flowchart showing an example of a process executed by the information processing device in the third embodiment; and

FIG. 10 is a block diagram showing functions of an information processing device in a fourth embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

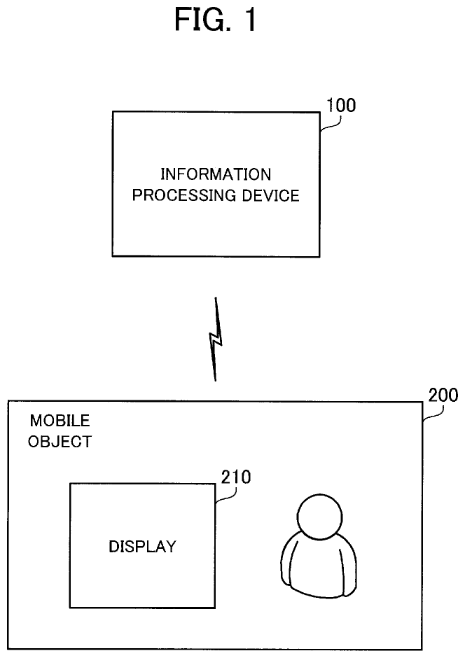

FIG. 1 is a diagram showing a provision system in a first embodiment. The provision system includes an information processing device 100 and a communication device. The information processing device 100 is a cloud server, for example. The communication device that communicates with the information processing device 100 is a mobile object 200, a terminal device, a signage or the like, for example. The mobile object 200 is a car, a taxi, a bus, a marine vessel, a small aircraft (e.g., drone) or the like, for example. The terminal device is a smartphone, a tablet terminal or the like, for example. The signage is a display or the like placed at a bus/train stop, for example. The signage may be equipped with a speaker for outputting voice or music. In the following description, the communication device is assumed to be the mobile object 200.

The information processing device 100 and the mobile object 200 communicate with each other by radio. The information processing device 100 is a device that executes a provision method.

The mobile object 200 includes a display 210. Further, the mobile object 200 is equipped with a speaker. The illustration of the speaker is left out. FIG. 1 shows a state in which a user is in, on or on board the mobile object 200. The user can acquire information by viewing the display 210. Incidentally, an identifier (ID) of the user is assumed to be “U1”.

Next, hardware included in the information processing device 100 will be described below.

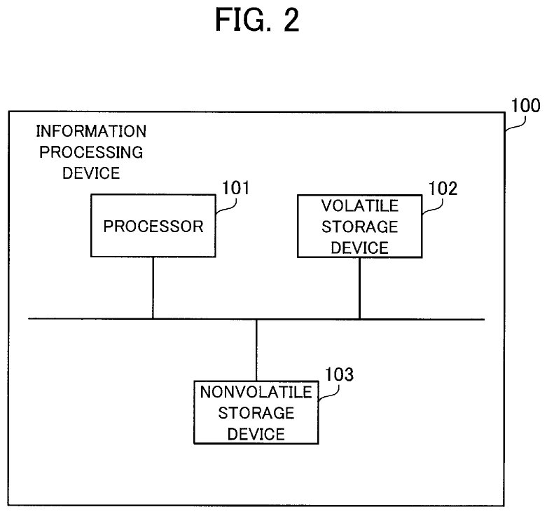

FIG. 2 is a diagram showing the hardware included in the information processing device in the first embodiment. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include a processing circuitry. The processing circuitry may be either a single circuit or a combined circuit.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Next, functions included in the information processing device 100 will be described below.

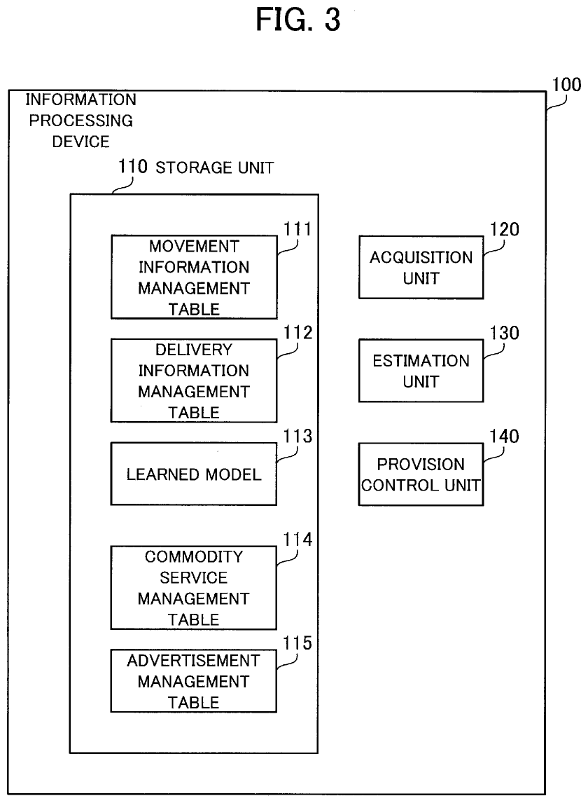

FIG. 3 is a block diagram showing the functions of the information processing device in the first embodiment. The information processing device 100 includes a storage unit 110, an acquisition unit 120, an estimation unit 130 and a provision control unit 140.

The storage unit 110 may be implemented as a storage area reserved in the volatile storage device 102 or the nonvolatile storage device 103.

Part or all of the acquisition unit 120, the estimation unit 130 and the provision control unit 140 may be implemented by a processing circuitry. Further, part or all of the acquisition unit 120, the estimation unit 130 and the provision control unit 140 may be implemented as modules of a program executed by the processor 101. For example, the program executed by the processor 101 is referred to also as a provision program. The provision program has been recorded in a record medium, for example.

The storage unit 110 may store a movement information management table 111, a delivery information management table 112, a learned model 113, a commodity service management table 114 and an advertisement management table 115. The movement information management table 111, the delivery information management table 112, the learned model 113, the commodity service management table 114 and the advertisement management table 115 will be described in detail later.

The acquisition unit 120 acquires user identification information. For example, the acquisition unit 120 acquires the user identification information from the mobile object 200. The user identification information is information identifying the user. Specifically, the user identification information is information capable of uniquely identifying the user. For example, the user identification information is a user ID, a user name, a fingerprint, a facial image, a speech uttered by the user, or the like acquired through a touch panel, a camera, a microphone or the like installed in the mobile object 200. In the following description, the user identification information is assumed to be the user ID. For example, the acquisition unit 120 acquires the user ID “U1”.

The acquisition unit 120 acquires present position information. For example, the acquisition unit 120 acquires the present position information from the mobile object 200. The present position information is information indicating the user's present position. For example, the present position information is information acquired by a Global Positioning System (GPS) installed in the mobile object 200.

The acquisition unit 120 acquires destination information. For example, the acquisition unit 120 acquires the destination information from the mobile object 200. The destination information is information indicating a destination. The destination is a place that the user is heading for. For example, the destination information is information inputted to the mobile object 200 by the user.

The acquisition unit 120 acquires a movement history record corresponding to the user ID by using the user ID. In other words, the acquisition unit 120 acquires a movement history record of a user corresponding to the user ID by using the user ID. For example, the acquisition unit 120 acquires the movement history record corresponding to the user ID by using the user ID and the movement information management table 111. Here, the movement information management table 111 will be described below.

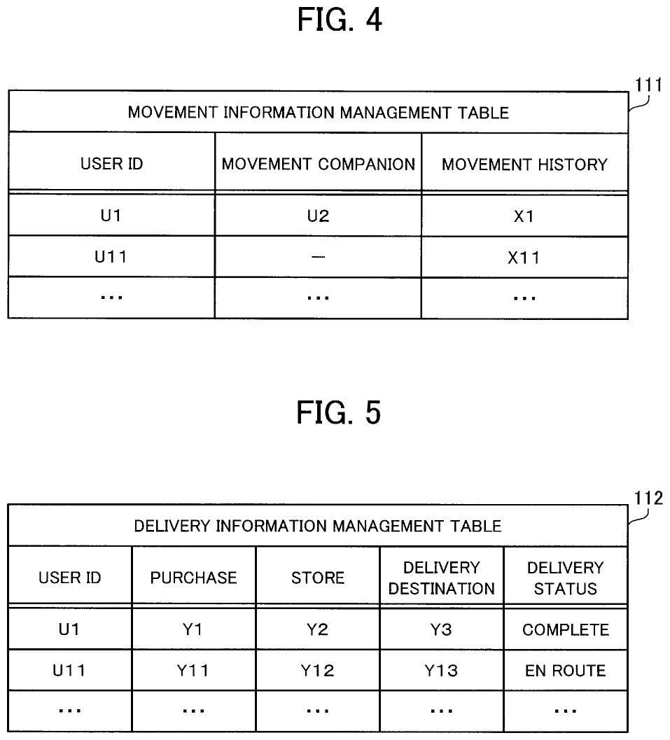

FIG. 4 is a diagram showing an example of the movement information management table in the first embodiment. For example, the movement information management table 111 has been stored in the storage unit 110. The movement information management table 111 includes items of user ID, movement companion and movement history. In the item of user ID, a user ID is registered. In the item of movement companion, a user ID of a companion who moves together is registered. In the item of movement history, a movement history record is registered. For example, the movement history record includes a place (e.g., a shop or a sightseeing place) to which the user went in the past. The place may be represented by latitude and longitude. A time of arrival at the place or a staying time at the place may also be associated with the place indicated by the movement history record.

For example, the acquisition unit 120 acquires a movement history record “X1” corresponding to the user ID “U1” by using the user ID “U1” and the movement information management table 111.

Here, the movement information management table 111 may also be stored in an external device (e.g., server) connectable to the information processing device 100. In the case where the movement information management table 111 is stored in an external device, the information processing device 100 transmits the user ID and a movement history transmission command to the external device, by which the acquisition unit 120 can acquire the movement history record corresponding to the user ID from the external device.

The acquisition unit 120 acquires purchase information, store information and delivery destination information corresponding to the user ID by using the user ID. For example, the acquisition unit 120 acquires the purchase information, the store information and the delivery destination information corresponding to the user ID by using the user ID and the delivery information management table 112. The purchase information is information indicating an item (purchased item) purchased by the user in the past. The store information is information regarding a store that sold the purchased item. The delivery destination information is information regarding a delivery destination of the purchased item. Here, the delivery information management table 112 will be described below.

FIG. 5 is a diagram showing an example of the delivery information management table in the first embodiment. For example, the delivery information management table 112 has been stored in the storage unit 110. The delivery information management table 112 includes items of user ID, purchase, store, delivery destination and delivery status.

In the item of user ID, a user ID is registered. In the item of purchase, an item (purchased item) purchased by a user in the past is registered. In the item of store, a store that sold the purchased item or the address of the store is registered. In the item of delivery destination, the delivery destination of the purchased item is registered. For example, in the item of delivery destination, the user's house, a hotel where the user is staying, or the address of the house or the hotel is registered. In the item of delivery status, the delivery status is registered.

For example, FIG. 5 indicates that the user of the user ID “U1” purchased an item “Y1” at a store “Y2”. Further, FIG. 5 indicates that arrangement for delivering the purchased item “Y1” to a delivery destination “Y3” was made by the store “Y2”.

For example, by using the user ID “U1” and the delivery information management table 112, the acquisition unit 120 acquires the purchase information (i.e., information indicating the purchased item “Y1”), the store information (i.e., information indicating the store “Y2”) and the delivery destination information (i.e., information indicating the delivery destination “Y3”) corresponding to the user ID “U1”.

Here, the delivery information management table 112 may also be stored in an external device. In the case where the delivery information management table 112 is stored in an external device, the information processing device 100 transmits the user ID and a transmission command regarding the purchase information, the store information and the delivery destination information to the external device, by which the acquisition unit 120 can acquire the purchase information, the store information and the delivery destination information corresponding to the user ID from the external device.

The acquisition unit 120 acquires the learned model 113. For example, the acquisition unit 120 acquires the learned model 113 from the storage unit 110. Here, the learned model 113 may also be stored in an external device. In the case where the learned model 113 is stored in an external device, the acquisition unit 120 acquires the learned model 113 from the external device. Incidentally, the learned model 113 is referred to also as a first learned model.

The estimation unit 130 estimates an advertisement to be provided to the user by using the present position information, the destination information, the movement history record, the purchase information, the store information, the delivery destination information and the learned model 113. Incidentally, the advertisement is content indicating at least one of a commodity and a service. Thus, the advertisement can be content indicating both of a commodity and a service.

Here, inputting the present position information to the learned model 113 enables the learned model 113 to estimate an advertisement in consideration of the present position of the user.

Further, inputting the destination information to the learned model 113 enables the learned model 113 to estimate an advertisement in consideration of the destination. For example, when the destination is a sightseeing place, the learned model 113 is capable of estimating an advertisement of a commodity sold at the sightseeing place.

For example, inputting a movement history record to the learned model 113 enables the learned model 113 to estimate an advertisement in consideration of a place the user went to in the past. In short, the learned model 113 is capable of estimating an advertisement indicating a commodity or a service relevant to a place the user went to in the past.

For example, inputting the purchase information to the learned model 113 enables the learned model 113 to estimate an advertisement in consideration of the purchased item. In short, the learned model 113 is capable of estimating an advertisement indicating a commodity or a service relevant to the purchased item. When the purchased item is a liquor, for example, the learned model 113 is capable of estimating an advertisement of a liquor. Further, when the purchased item is a liquor, for example, the learned model 113 is capable of estimating an advertisement of a commodity (e.g., snack with alcohol) relevant to the liquor. This is because the user is considered to want a commodity relevant to a liquor when the purchased item is a liquor.

For example, inputting the store information to the learned model 113 enables the learned model 113 to estimate an advertisement in consideration of the category of the store. In short, the learned model 113 is capable of estimating an advertisement indicating a commodity or a service relevant to the category of the store. For example, when the store is a store selling ethnic costumes, the learned model 113 is capable of estimating an advertisement of an ethnic costume. Further, since it can be estimated that the user is unfamiliar with the ethnic costumes, the learned model 113 is capable of estimating an advertisement of a costume dressing service as the service relevant to ethnic costumes, for example.

For example, inputting the delivery destination information to the learned model 113 enables the learned model 113 to estimate an advertisement in consideration of information acquired from the delivery destination. In short, the learned model 113 is capable of estimating an advertisement indicating a commodity or a service relevant to the delivery destination. For example, when the delivery destination is a beachside hotel in Okinawa, it is estimated that the user is interested in Okinawa or the sea. Thus, the learned model 113 is capable of estimating an advertisement indicating a commodity or a service relevant to Okinawa or the sea.

As described above, the learned model 113 is capable of outputting at least one advertisement in consideration of a plurality of items of information relevant to the user. For example, when the movement history record indicates a sightseeing place in Okinawa, the purchase information indicates a liquor, the store information indicates a liquor store and the delivery destination information indicates a hotel in Okinawa, the learned model 113 outputs an advertisement of a store situated in the vicinity of the present position or the destination and selling Okinawan liquors. It is also possible for the learned model 113 to output an advertisement of a commodity (e.g., snack with alcohol) relevant to Okinawan liquors. Further, it is also possible for the learned model 113 to output an advertisement of a shop (i.e., restaurant) providing Okinawan liquors.

The learned model 113 may output a commodity ID. The learned model 113 may output a service ID. The learned model 113 may output a commodity ID and a service ID. In short, the estimation unit 130 may estimate identification information indicating at least one of a commodity of the advertisement and a service of the advertisement.

Here, the commodity service management table 114 indicates a correspondence relationship between a commodity ID and a commodity advertisement. The commodity advertisement is content indicating an advertisement of a commodity. Further, the commodity service management table 114 includes a correspondence relationship between a service ID and a service advertisement. The service advertisement is content indicating an advertisement of a service. As above, the commodity service management table 114 indicates a correspondence relationship between the identification information (i.e., at least one of a commodity ID and a service ID) and an advertisement.

The commodity service management table 114 is acquired by the acquisition unit 120. For example, the acquisition unit 120 acquires the commodity service management table 114 from the storage unit 110. Here, the commodity service management table 114 may also be stored in an external device. In the case where the commodity service management table 114 is stored in an external device, the acquisition unit 120 acquires the commodity service management table 114 from the external device. Incidentally, the commodity service management table 114 is referred to also as commodity service management information.

When a commodity ID is outputted, the provision control unit 140 refers to the commodity service management table 114 and acquires a commodity advertisement corresponding to the commodity ID. When a service ID is outputted, the provision control unit 140 refers to the commodity service management table 114 and outputs a service advertisement corresponding to the service ID. When a commodity ID and a service ID are outputted, the provision control unit 140 refers to the commodity service management table 114 and acquires an advertisement corresponding to the commodity ID and the service ID. As above, the provision control unit 140 acquires an advertisement based on the estimated identification information (i.e., the commodity ID and the service ID) and the commodity service management table 114.

Further, the learned model 113 may output an advertisement ID. In short, the estimation unit 130 may estimate the advertisement ID. The advertisement ID is identification information indicating an advertisement. Here, the advertisement management table 115 indicates a correspondence relationship between the advertisement ID and the advertisement. The advertisement management table 115 is acquired by the acquisition unit 120. For example, the acquisition unit 120 acquires the advertisement management table 115 from the storage unit 110. Here, the advertisement management table 115 may also be stored in an external device. In the case where the advertisement management table 115 is stored in an external device, the acquisition unit 120 acquires the advertisement management table 115 from the external device. Incidentally, the advertisement management table 115 is referred to also as advertisement management information. When an advertisement ID is outputted, the provision control unit 140 acquires an advertisement corresponding to the advertisement ID based on the advertisement ID and the advertisement management table 115.

The provision control unit 140 executes a process for providing the advertisement to the user. For example, the provision control unit 140 transmits the advertisement and a command for displaying the advertisement to the mobile object 200. Accordingly, the mobile object 200 displays the advertisement on the display 210. Incidentally, the content as the advertisement can be text data, an image or a video image. Further, the provision control unit 140 may transmit audio data representing the advertisement and a command for outputting audio based on the audio data to the mobile object 200. Accordingly, the mobile object 200 can output audio indicating the advertisement from the speaker of the mobile object 200.

Further, the information processing device 100 may relearn the learned model 113 by using information inputted to the learned model 113 and information outputted from the learned model 113. While the relearning usually means additional learning in regard to the learned model 113, the relearning can also be relearning from an initial state (i.e., new learning). The relearning of the learned model 113 can be executed by use of machine learning, for example. As the method of the machine learning, various methods are usable such as deep learning by using neural networks, decision tree, random forest, logistic regression, support vector machine or the like, for example.

Next, a process executed by the information processing device 100 will be described below by using a flowchart.

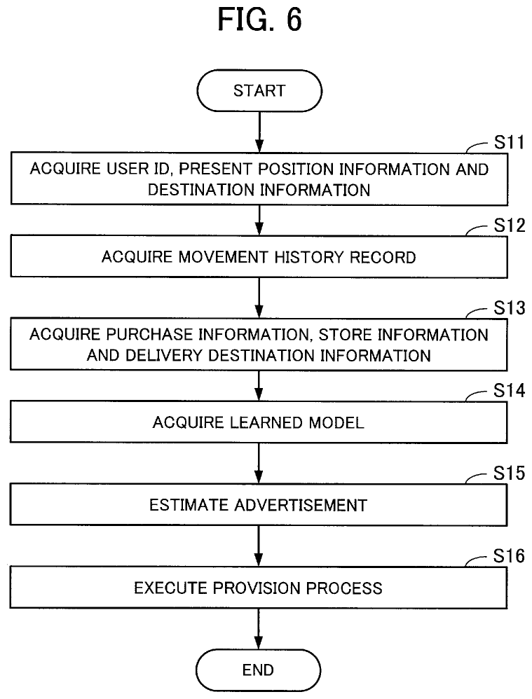

FIG. 6 is a flowchart showing an example of the process executed by the information processing device in the first embodiment.

(Step S11) The acquisition unit 120 acquires the user ID, the present position information and the destination information.

(Step S12) The acquisition unit 120 acquires the movement history record by using the user ID.

(Step S13) The acquisition unit 120 acquires the purchase information, the store information and the delivery destination information by using the user ID.

(Step S14) The acquisition unit 120 acquires the learned model 113.

(Step S15) The estimation unit 130 estimates an advertisement to be provided to the user by using the present position information, the destination information, the movement history record, the purchase information, the store information, the delivery destination information and the learned model 113.

(Step S16) The provision control unit 140 executes an advertisement provision process.

Incidentally, the order of acquisition of the present position information, the destination information, the movement history record, the purchase information, the store information, the delivery destination information and the learned model 113 does not necessarily have to be the order shown in FIG. 6.

Incidentally, in the technology of the Patent Reference 1, the advertisement data based on the movement history record is displayed. However, there are cases where the advertisement data based exclusively on the movement history record cannot be regarded as an advertisement appropriate for the user.

The information processing device 100 estimates an advertisement to be provided to the user by using a plurality of items of information relevant to the user. The information processing device 100 does not estimate the advertisement by using only one item of information. By using a plurality of items of information, the information processing device 100 is capable of estimating an advertisement in consideration of various preferences of the user. In short, by using a plurality of items of information, the information processing device 100 is capable of estimating an advertisement appropriate for the user. Further, by combining information regarding the movement such as the present position information and information regarding the delivery such as the purchase information, the information processing device 100 is capable of estimating an advertisement in consideration of the information regarding the delivery as well. Then, the information processing device 100 provides the estimated advertisement to the user. Thus, according to the first embodiment, the information processing device 100 is capable of providing an advertisement appropriate for the user.

Further, a mobile object, a terminal device or the like may also be configured to have the functions of the information processing device 100. An example of a process executed by a mobile object in the case where the mobile object has the functions of the information processing device 100 will be described below. The mobile object acquires the user ID inputted to the mobile object by the user. The mobile object acquires the present position information by using a GPS installed in the mobile object. The mobile object acquires the destination information inputted to the mobile object by the user (step S11). The mobile object transmits the user ID and the movement history transmission command to an external device storing the movement information management table 111. Accordingly, the mobile object acquires the movement history record corresponding to the user ID from the external device (step S12). The mobile object transmits the user ID and a command for transmitting the purchase information, the store information and the delivery destination information to an external device storing the delivery information management table 112. Accordingly, the mobile object acquires the purchase information, the store information and the delivery destination information corresponding to the user ID from the external device (step S13). The mobile object acquires the learned model 113 from a storage device included in the mobile object (step S14). The mobile object estimates an advertisement to be provided to the user by using the present position information, the destination information, the movement history record, the purchase information, the store information, the delivery destination information and the learned model 113 (step S15). The mobile object executes an advertisement provision process (step S16). Specifically, the mobile object executes a process for displaying the advertisement on a display of the mobile object. Accordingly, the advertisement is displayed on the display. As above, a mobile object, a terminal device or the like may also be configured to have the functions of the information processing device 100. In the case where a mobile object, a terminal device or the like has the functions of the information processing device 100, the mobile object, terminal device or the like may be referred to as an information processing device.

### Second Embodiment

Next, a second embodiment will be described below. In the second embodiment, the description will be given mainly of features different from those in the first embodiment. In the second embodiment, the description will be omitted for features in common with the first embodiment.

In the second embodiment, the acquisition unit 120 further acquires attribute information. The attribute information is information indicating an attribute of the user. Specifically, the attribute information can include sex, age, family composition, country of origin, job, income, or the like. The estimation unit 130 uses the attribute information when estimating the advertisement.

Next, a process executed by the information processing device 100 will be described below by using a flowchart.

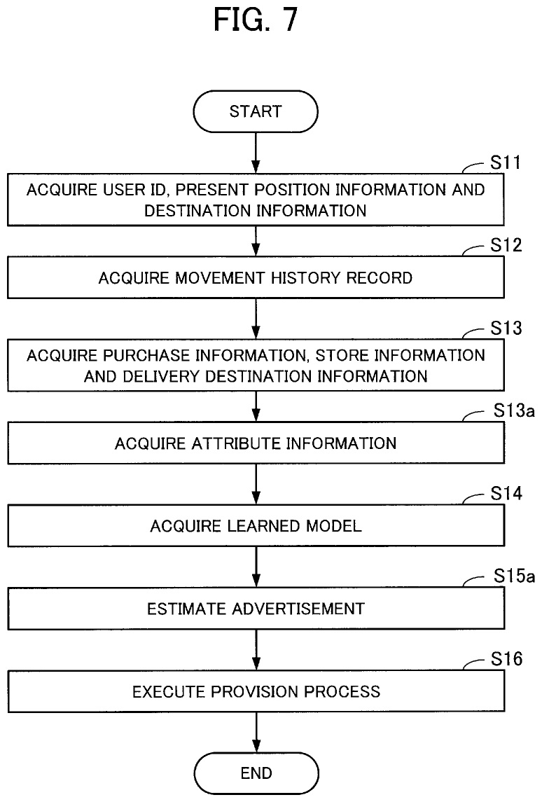

FIG. 7 is a flowchart showing an example of the process executed by the information processing device in the second embodiment. The process of FIG. 7 differs from the process of FIG. 6 in that steps S13a and S15a are executed. Therefore, the steps S13a and S15a will be described below with reference to FIG. 7. Then, the description will be omitted for processing other than the steps S13a and S15a.

(Step S13a) The acquisition unit 120 acquires the attribute information. For example, the acquisition unit 120 acquires the attribute information from the mobile object 200. In a case where user information indicating a correspondence relationship between the user ID and the attribute information has been stored in the storage unit 110, for example, the acquisition unit 120 acquires the attribute information based on the user ID and the user information. Here, the movement information management table 111 or the delivery information management table 112 may include the attribute information. In the case where the movement information management table 111 or the delivery information management table 112 includes the attribute information, the acquisition unit 120 acquires the attribute information from the movement information management table 111 or the delivery information management table 112.

(Step S15a) The estimation unit 130 estimates an advertisement to be provided to the user by using the present position information, the destination information, the movement history record, the purchase information, the store information, the delivery destination information, the attribute information and the learned model 113.

According to the second embodiment, the information processing device 100 estimates the advertisement in consideration of the attribute information as well. Therefore, the estimated advertisement can be regarded as an advertisement more appropriate for the user. Accordingly, the information processing device 100 is capable of providing an advertisement more appropriate for the user.

### Third Embodiment

Next, a third embodiment will be described below. In the third embodiment, the description will be given mainly of features different from those in the first embodiment. In the third embodiment, the description will be omitted for features in common with the first embodiment.

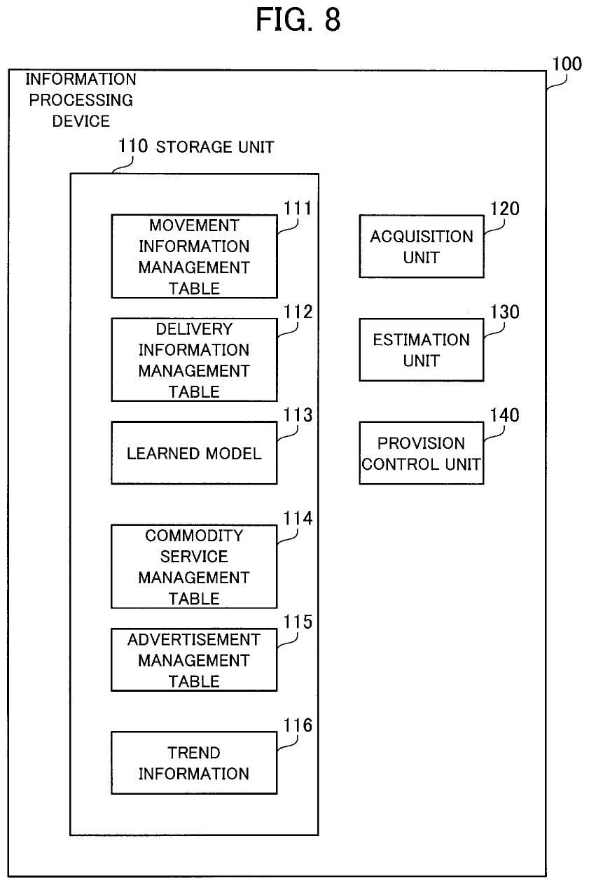

FIG. 8 is a block diagram showing functions of an information processing device in the third embodiment. The storage unit 110 may further store trend information 116. The trend information 116 is information indicating the current trend. For example, the trend information 116 may be generated based on a Social Networking Service (SNS). The trend information 116 may be acquired in real time by using a communication means such as the Internet, for example.

The acquisition unit 120 acquires the trend information 116. For example, the acquisition unit 120 acquires the trend information 116 from the storage unit 110. The trend information 116 may also be stored in an external device. In the case where the trend information 116 is stored in an external device, the acquisition unit 120 acquires the trend information 116 from the external device. The estimation unit 130 uses the trend information 116 when estimating the advertisement.

Next, a process executed by the information processing device 100 will be described below by using a flowchart.

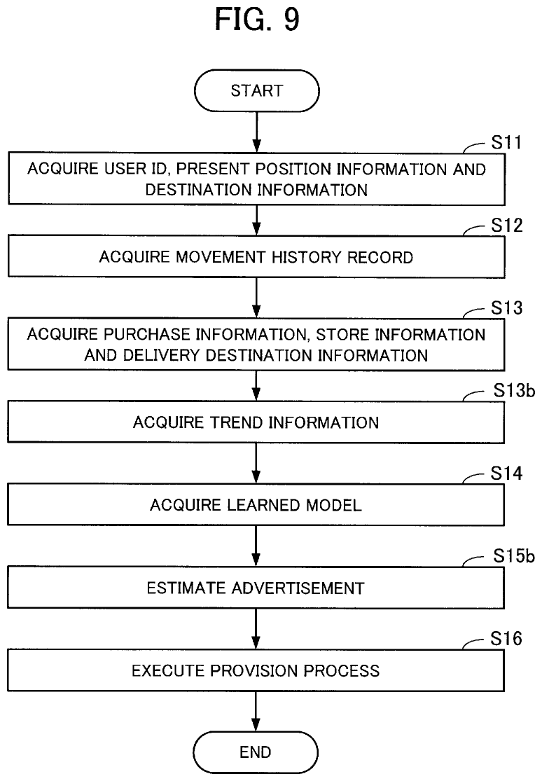

FIG. 9 is a flowchart showing an example of the process executed by the information processing device in the third embodiment. The process of FIG. 9 differs from the process of FIG. 6 in that steps S13b and S15b are executed. Therefore, the steps S13b and S15b will be described below with reference to FIG. 9. Then, the description will be omitted for processing other than the steps S13b and S15b.

(Step S13b) The acquisition unit 120 acquires the trend information 116.

(Step S15b) The estimation unit 130 estimates an advertisement to be provided to the user by using the present position information, the destination information, the movement history record, the purchase information, the store information, the delivery destination information, the trend information 116 and the learned model 113.

According to the third embodiment, the information processing device 100 estimates the advertisement in consideration of the trend information 116 as well. Therefore, the information processing device 100 is capable of estimating an advertisement in consideration of the trend. Accordingly, the information processing device 100 is capable of providing an advertisement in consideration of the trend to the user.

Incidentally, in the first to third embodiments, the description was given of the cases where all items of information acquired by the acquisition unit 120 are inputted to the learned model 113. For example, in the first embodiment, the description was given of the case where the present position information, the destination information, the movement history record, the purchase information, the store information and the delivery destination information are inputted to the learned model 113. However, the estimation unit 130 does not need to estimate the advertisement by inputting all items of information to the learned model 113. As an example, the estimation unit 130 estimates the advertisement by using position information, as at least one item of information out of the present position information and the destination information, the purchase information, and the learned model 113. As another example, the estimation unit 130 estimates the advertisement by using the present position information, the destination information, the purchase information and the learned model 113. As another example, the estimation unit 130 estimates the advertisement by using the position information, the purchase information, the movement history record and the learned model 113. As another example, the estimation unit 130 estimates the advertisement by using the position information, the purchase information, the store information and the learned model 113. As another example, the estimation unit 130 estimates the advertisement by using the position information, the purchase information, the delivery destination information and the learned model 113. As another example, the estimation unit 130 estimates the advertisement by using the position information, the purchase information, the attribute information and the learned model 113. As another example, the estimation unit 130 estimates the advertisement by using the position information, the purchase information, the trend information 116 and the learned model 113. As above, the estimation unit 130 may estimate the advertisement by inputting a variety of combination based on the plurality of items of information acquired by the acquisition unit 120 to the learned model 113.

### Fourth Embodiment

Next, a fourth embodiment will be described below. In the fourth embodiment, the description will be given mainly of features different from those in the first embodiment. In the fourth embodiment, the description will be omitted for features in common with the first embodiment.

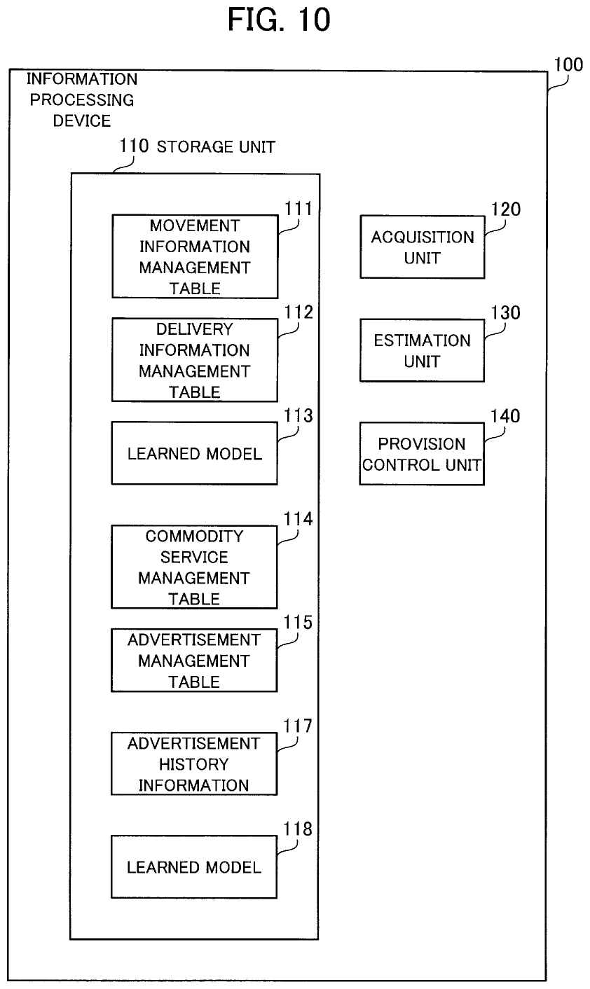

FIG. 10 is a block diagram showing functions of an information processing device in the fourth embodiment. The storage unit 110 may further store advertisement history information 117 and a learned model 118. Incidentally, the learned model 118 is referred to also as a second learned model.

Here, information indicating the advertisement estimated by the estimation unit 130 may be stored in the storage unit 110. Further, the information indicating the advertisement may be stored in the storage unit 110 each time the estimation unit 130 executes the estimation. Information indicating a plurality of estimated advertisements is the advertisement history information 117. Further, the advertisement history information 117 may also be stored in an external device.

The acquisition unit 120 acquires the advertisement history information 117 from the storage unit 110. In the case where the advertisement history information 117 is stored in an external device, the acquisition unit 120 acquires the advertisement history information 117 from the external device.

Further, the acquisition unit 120 acquires the learned model 118 from the storage unit 110. The learned model 118 may also be stored in an external device. In the case where the learned model 118 is stored in an external device, the acquisition unit 120 acquires the learned model 118 from the external device.

The estimation unit 130 estimates at least one of a commodity and a service to be recommended to a provider by using the advertisement history information 117 and the learned model 118. Incidentally, the provider is a person that provides at least one of a commodity and a service.

The provision control unit 140 executes a process of outputting information indicating the estimated at least one of a commodity and a service. As an example, the provision control unit 140 transmits the information indicating the estimated at least one of a commodity and a service to a terminal device used by the provider. As another example, the provision control unit 140 transmits the information indicating the estimated at least one of a commodity and a service to a terminal device used by a sales representative. In a case where the information processing device 100 is a terminal device, for example, the provision control unit 140 executes a process for displaying the information indicating the estimated at least one of a commodity and a service on a display of the terminal device.

As above, the information processing device 100 outputs the information indicating at least one of a commodity and a service to be recommended to the provider based on a plurality of advertisements estimated in the past. For example, the provider can understand consumer inclination by viewing the terminal device used by the provider. Then, the provider performs sales activities based on the consumer inclination and that leads to an increase in the amount of sales. Further, for example, the sales representative can understand the consumer inclination by viewing the terminal device used by the sales representative. The sales representative can perform the sales activities based on the consumer inclination.

According to the fourth embodiment, the information processing device 100 is capable of outputting beneficial information.

Features in the embodiments described above can be appropriately combined with each other.

### DESCRIPTION OF REFERENCE CHARACTERS

100: information processing device, 101: processor, 102: volatile storage device, 103: nonvolatile storage device, 110: storage unit, 111: movement information management table, 112: delivery information management table, 113: learned model, 114: commodity service management table, 115: advertisement management table, 116: trend information, 117: advertisement history information, 118: learned model, 120: acquisition unit, 130: estimation unit, 140: provision control unit, 200: mobile object, 210: display

What is claimed is:

1. An information processing device comprising:
acquiring circuitry to acquire user identification information as information identifying a user and position information as at least one item of information out of present position information as information indicating the user's present position and destination information as information indicating a destination, acquire purchase information indicating a purchased item purchased by the user in the past by using the user identification information, acquire delivery destination information by using the user identification information, and acquire a first learned model, the delivery destination information being information regarding a delivery destination of the purchased item and information indicating that the delivery destination is a place other than the user's address;
estimating circuitry to estimate an advertisement to be provided to the user by using the position information, the purchase information, the delivery destination information and the first learned model; and
provision controlling circuitry to execute a process for providing the advertisement to the user.

2. The information processing device according to claim 1, wherein the estimating circuitry estimates the advertisement by using the present position information, the destination information, the purchase information, the delivery destination information and the first learned model.

3. The information processing device according to claim 1, wherein
the acquiring circuitry acquires a movement history record of the user by using the user identification information, and
the estimating circuitry estimates the advertisement by using the position information, the purchase information, the delivery destination information, the movement history record and the first learned model.

4. The information processing device according to claim 1, wherein
the acquiring circuitry acquires store information as information regarding a store that sold the purchased item by using the user identification information, and
the estimating circuitry estimates the advertisement by using the position information, the purchase information, the delivery destination information, the store information and the first learned model.

5. The information processing device according to claim 1, wherein
the acquiring circuitry acquires attribute information indicating an attribute of the user, and
the estimating circuitry estimates the advertisement by using the position information, the purchase information, the delivery destination information, the attribute information and the first learned model.

6. The information processing device according to claim 1, wherein
the acquiring circuitry acquires trend information indicating a current trend, and
the estimating circuitry estimates the advertisement by using the position information, the purchase information, the delivery destination information, the trend information and the first learned model.

7. The information processing device according to claim 1, wherein
the estimating circuitry estimates identification information indicating at least one of a commodity and a service of the advertisement,
the acquiring circuitry acquires commodity service management information indicating a correspondence relationship between the identification information and the advertisement, and
the provision controlling circuitry acquires the advertisement based on the estimated identification information and the commodity service management information.

8. The information processing device according to claim 1, wherein
the estimating circuitry estimates identification information indicating the advertisement,
the acquiring circuitry acquires advertisement management information indicating a correspondence relationship between the identification information and the advertisement, and
the provision controlling circuitry acquires the advertisement based on the estimated identification information and the advertisement management information.

9. The information processing device according to claim 1, wherein
the acquiring circuitry acquires advertisement history information indicating a plurality of estimated advertisements and a second learned model,
the estimating circuitry estimates at least one of a commodity and a service to be recommended to a provider providing at least one of a commodity and a service by using the advertisement history information and the second learned model, and
the provision controlling circuitry executes a process of outputting information indicating the estimated at least one of a commodity and a service.

10. A provision system comprising:
a mobile object where a user is situated; and
an information processing device,
wherein the information processing device includes:
acquiring circuitry to acquire user identification information as information identifying the user and position information as at least one item of information out of present position information as information indicating the user's present position and destination information as information indicating a destination, acquire purchase information indicating a purchased item purchased by the user in the past by using the user identification information, acquire delivery destination information by using the user identification information, and acquire a first learned model, the delivery destination information being information regarding a delivery destination of the purchased item and information indicating that the delivery destination is a place other than the user's address;
estimating circuitry to estimate an advertisement to be provided to the user by using the position information, the purchase information, the delivery destination information and the first learned model; and
provision controlling circuitry to execute a process for providing the advertisement to the user.

11. A provision method performed by an information processing device, the provision method comprising:
acquiring user identification information as information identifying a user and position information as at least one item of information out of present position information as information indicating the user's present position and destination information as information indicating a destination, acquiring purchase information indicating a purchased item purchased by the user in the past by using the user identification information, acquiring delivery destination information by using the user identification information, and acquiring a first learned model, the delivery destination information being information regarding a delivery destination of the purchased item and information indicating that the delivery destination is a place other than the user's address;
estimating an advertisement to be provided to the user by using the position information, the purchase information, the delivery destination information and the first learned model; and
executing a process for providing the advertisement to the user.

12. An information processing device comprising:
a processor to execute a program; and
a memory to store the program which, when executed by the processor, performs processes of,
acquiring user identification information as information identifying a user and position information as at least one item of information out of present position information as information indicating the user's present position and destination information as information indicating a destination, acquiring purchase information indicating a purchased item purchased by the user in the past by using the user identification information, acquiring delivery destination information by using the user identification information, and acquiring a first learned model, the delivery destination information being information regarding a delivery destination of the purchased item and information indicating that the delivery destination is a place other than the user's address;
estimating an advertisement to be provided to the user by using the position information, the purchase information, the delivery destination information and the first learned model; and
executing a process for providing the advertisement to the user.
